(19) United States
(12) Patent Application Publication
(10) Pub. No.: US 2020/0374705 A1
(43) Pub. Date: Nov. 26, 2020

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventor: Kazuki MATSUMOTO, Ogaki-shi (JP)

(73) Assignee: TOYOTA JIDOSHA KABUSHIKI KAISHA, Toyota-shi (JP)

(21) Appl. No.: 16/859,333

(22) Filed: Apr. 27, 2020

(30) Foreign Application Priority Data
May 21, 2019 (JP) 2019-095399

(51) Int. Cl. H04W 16/18; H04W 4/44; H04W 4/02

(52) U.S. Cl. CPC H04W 16/18; H04W 4/027; H04W 4/44

(57) ABSTRACT

An information processing device according to an embodiment of the disclosure includes a communication environment map generation unit configured to, based on information representing a communication environment of 5G at a predetermined point acquired by a plurality of vehicles passing through the predetermined point and vehicle information relating to the communication environment of 5G at the predetermined point, determine a communication environment of 5G in a vehicle at the predetermined point.

### INCORPORATION BY REFERENCE

The disclosure of Japanese Patent Application No. 2019-095399 filed on May 21, 2019 including the specification, drawings and abstract is incorporated herein by reference in its entirety.

### BACKGROUND

### 1. Technical Field

The present disclosure relates to an information processing device and the like.

### 2. Description of Related Art

A technique that determines a communication environment of a target vehicle after passing through a current place based on a communication environment of another vehicle having passed through a point corresponding to the current place of the target vehicle in the past is known (for example, see Japanese Unexamined Patent Application Publication No. 2016-018234 (JP 2016-018234 A)).

According to such a technique, it is possible to determine the communication environment of the target vehicle that changes every moment after the target vehicle has passed through the current place.

### SUMMARY

Incidentally, as enormous data, such as image data, is transmitted from a vehicle through communication using a 5^{th} generation (5G) mobile communication system scheduled to be introduced in future, high-speed upload of enormous data to an external device is expected.

However, there is a possibility that a communication environment in a vehicle is affected by conditions peculiar to the vehicle, such as a moving direction of the vehicle, a vehicle speed, the type of an antenna, and an attachment position of the antenna, because of a characteristic that a radio wave having strong directivity using beam forming of 5G is used. For this reason, for example, even though a vehicle is within an area where communication using 5G disclosed by a communication carrier can be performed, communication using 5G may not be satisfactorily performed in the vehicle depending on the conditions peculiar to the vehicle, and there is a possibility that a long time is needed to upload enormous data. Accordingly, it is desirable that a communication environment of 5G in a vehicle can be appropriately determined.

The disclosure provides an information processing device and the like capable of appropriately determine a communication environment of 5G in a vehicle.

An embodiment of the disclosure relates to an information processing device. The information processing device includes a determination unit. The determination unit is configured to, based on information representing a communication environment of 5G at a predetermined point acquired by a vehicle passing through the predetermined point and vehicle information relating to the communication environment of 5G at the predetermined point, determine a communication environment of 5G in a vehicle at the predetermined point.

According to the embodiment, the information processing device can consider a condition peculiar to a vehicle affecting the communication environment of 5G based on the vehicle information relating to the communication environment of 5G. For this reason, the information processing device can appropriately determine the communication environment of 5G in the vehicle at the predetermined point taking into consideration the conditions peculiar to the vehicle affecting the communication environment of 5G.

In the above-described embodiment, the vehicle information relating to the communication environment may include at least one of a vehicle speed of a vehicle at the predetermined point, a moving direction of a vehicle at the predetermined point, a type of an antenna of 5G mounted in a vehicle, and an attachment position of the antenna in a vehicle.

According to the embodiment, the information processing device can specifically determine the communication environment of 5G at the predetermined point taking into consideration the conditions peculiar to the vehicle, such as the vehicle speed of the vehicle, the moving direction of the vehicle, the type of the antenna of 5G, and the attachment position of the antenna of 5G.

In the above-described embodiment, the determination unit may be configured to determine the communication environment of 5G in a vehicle at the predetermined point based on information representing the communication environment acquired by a plurality of vehicles passing through the predetermined point and the vehicle information relating to the communication environment and generate map information, in which a geographical range including a plurality of the predetermined points and a communication environment of 5G in a vehicle are associated with each other, based on determination results for the predetermined points.

According to the embodiment, the information processing device can ascertain the communication environment of 5G in the vehicle for a specific geographical range by itself or can make an external device ascertain the communication environment of 5G in the vehicle for the specific geographical range based on the map information.

Other embodiments of the disclosure can be implemented as an information processing method and a program.

According to the above-described embodiments, it is possible to provide an information processing device and the like capable of appropriately determining a communication environment of 5G in a vehicle.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic view showing an example of the configuration of an information providing system;

FIG. 2A is a diagram showing an example of the configuration of a vehicle;

FIG. 2B is a diagram showing an example of the configuration of a center server;

FIG. 3 is a functional block diagram showing an example of the functional configuration of the information providing system;

FIG. 4A is a diagram illustrating an example of a communication environment map image; and

FIG. 4B is a diagram illustrating an example of a communication environment map image.

### DETAILED DESCRIPTION OF EMBODIMENTS

Hereinafter, a mode for carrying out the disclosure will be described referring to the drawings.

Outline of Information Providing System

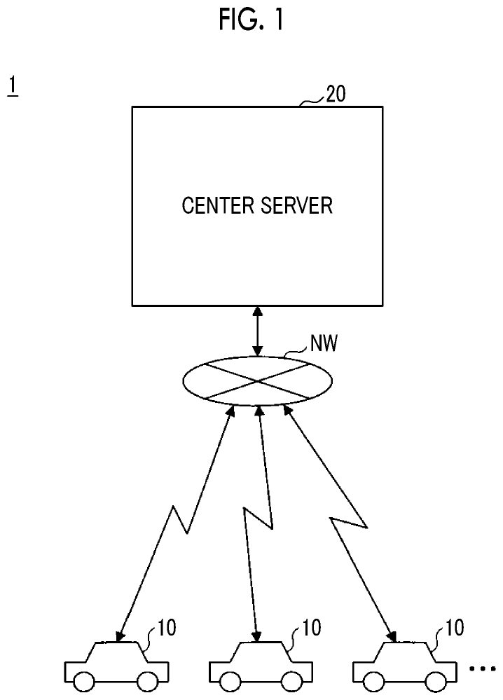

First, the outline of an information providing system 1 according to an embodiment will be described referring to FIG. 1.

The information providing system 1 includes a plurality of vehicles 10 and a center server 20.

The information providing system 1 collects information (hereinafter, referred to as “communication environment information”) relating to a communication environment of 5G acquired by the vehicles 10 and determines a communication environment of 5G in the vehicle 10 in a predetermined geographical range (hereinafter, referred to as a “target area”) in the center server 20. Specifically, the information providing system 1 determines a communication environment of 5G in a vehicle 10 at each of a plurality of points (hereinafter, referred to as “target points”) within the target area and generates map information (hereinafter, referred to as a “communication environment map”) in which the target point within the target area and a determination result of the communication environment of 5G in the vehicle 10 at the target point are associated with each other. Then, the information providing system 1 provides the communication environment map from the center server 20 to the vehicle 10 or a predetermined external device.

In communication environment related information, information (for example, information relating to reception sensitivity of radio waves of 5G) (hereinafter, referred to as “communication environment status information”) representing an actual communication environment of 5G in the vehicle 10 and vehicle information (hereinafter, referred to as “communication environment related vehicle information”) relating to the communication environment of 5G in the vehicle 10 are included. The communication environment related vehicle information is vehicle information corresponding to the conditions peculiar to the vehicle 10 affecting the communication environment of 5G. In the communication environment related vehicle information, for example, a vehicle speed of the vehicle 10, a moving direction of the vehicle 10, the type of an antenna of 5G attached to the vehicle 10, an attachment position of the antenna of 5G in the vehicle 10, and the like may be included. The type of the antenna of 5G includes a fin type antenna, a dashboard embedded type antenna, a roof type antenna, or the like. The fin type antenna is attached, for example, near a right-left center in a rear end portion of a top surface (roof portion) of the vehicle 10. The dashboard embedded type antenna is attached inside a dashboard (instrument panel). The roof type antenna may be attached at any position of the top surface (roof portion) of the vehicle 10.

The vehicle 10 is connected to the center server 20 in a communicable manner, for example, through a communication network NW including a mobile communication network with base stations as terminals. Within the target area, the vehicle 10 acquires communication environment information and transmits (uploads), to the center server 20, the communication environment information and positional information of the vehicle 10 when the communication environment information is acquired.

The center server 20 (an example of an information processing device) is connected to each of the vehicles 10 in a communicable manner through the communication network NW. The center server 20 receives the communication environment information and the positional information of the vehicle 10 corresponding to the communication environment information transmitted from the vehicle 10 and generates a communication environment map based on the received information. The center server 20 distributes the generated communication environment map to the vehicle 10.

Configuration of Information Providing System

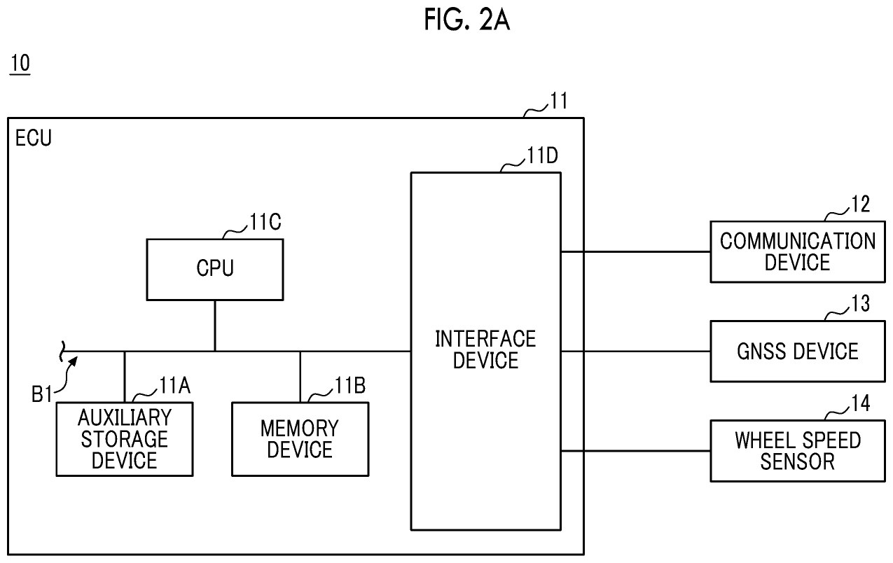

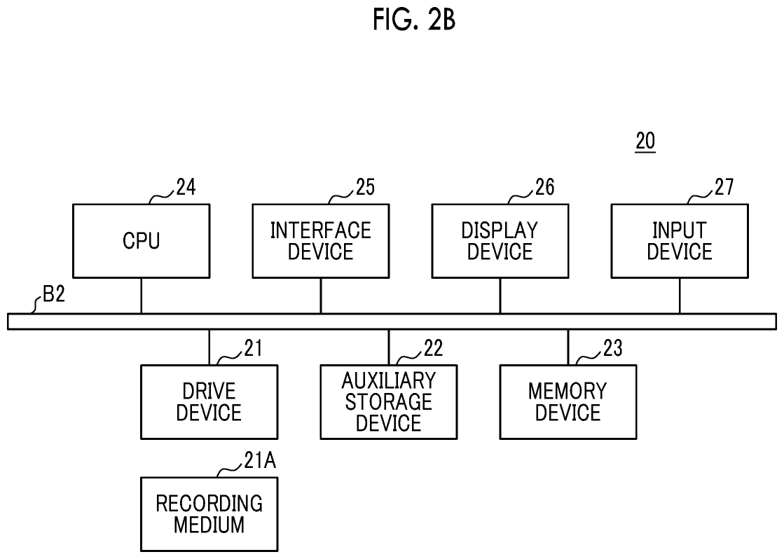

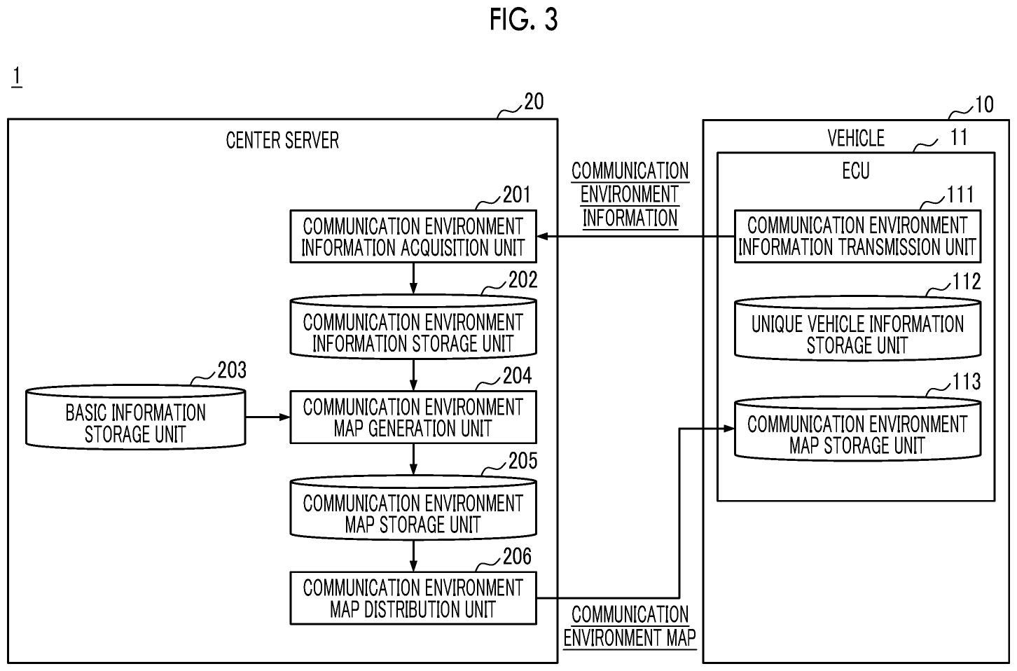

Next, the configuration of the information providing system 1 will be described referring to FIGS. 2A, 2B, and 3, in addition to FIG. 1.

FIGS. 2A and 2B are diagrams showing an example of the configuration of the information providing system 1. Specifically, FIG. 2A is a diagram showing an example of the configuration of the vehicle 10, and FIG. 2B is a diagram showing an example of the configuration of the center server 20. FIG. 3 is a functional block diagram showing an example of the functional configuration of the information providing system 1.

Configuration of Vehicle

As shown in FIG. 2A, the vehicle 10 includes an electronic control unit (ECU) 11, a communication device 12, a global navigation satellite system (GNSS) device 13, and a wheel speed sensor 14.

The ECU 11 is an electronic control unit that performs various kinds of control relating to the vehicle 10. The functions of the ECU 11 may be implemented by any hardware or a combination of hardware and software. For example, the ECU 11 may be constituted centering on a microcomputer including an auxiliary storage device 11A, a memory device 11B, a central processing unit (CPU) 11C, an interface device 11D, and the like connected through a bus B1.

Programs that implement various functions of the ECU 11 are provided, for example, by a dedicated tool that is connected through a cable attachable to and detachable from a predetermined connector (for example, a data link coupler (DLC)) for external connection connected to an in-vehicle network, such as a controller area network (CAN), of the vehicle 10. The programs are installed on the auxiliary storage device 11A of the ECU 11 from the dedicated tool through the cable, the connector, and the in-vehicle network according to a predetermined operation in the dedicated tool. The programs may be downloaded from another computer (for example, the center server 20) through the communication network NW and may be installed on the auxiliary storage device 11A.

The auxiliary storage device 11A is a nonvolatile storage unit. The auxiliary storage device 11A stores the installed programs and stores needed files, data, and the like. The auxiliary storage device 11A is, for example, a hard disk drive (HDD), a flash memory, or the like.

When a start instruction of the programs is given, the memory device 11B reads the programs from the auxiliary storage device 11A and stores the programs.

The CPU 11C executes the programs stored in the memory device 11B and implements various functions of the ECU 11 according to the programs.

The interface device 11D is used, for example, as an interface for connection to the in-vehicle network or for connection to various sensors, an actuator, and the like on a one-to-one basis. The interface device 11D may include a plurality of different kinds of interface devices in conformity with connection targets.

The communication device 12 is a communication device that is connected to the communication network NW outside the vehicle 10, and performs communication with external devices including the center server 20 through the communication network NW. The communication device 12 has a communication function using a mobile communication network of 5G, and includes an antenna of 5G. The communication device 12 performs transmission and reception of various signals (for example, information signals, control signals, and the like) to and from the center server 20. The communication device 12 is connected to the ECU 11 in a communicable manner through a one-to-one communication line or the in-vehicle network, such as a CAN, and transmits various signals to the outside of the vehicle 10 (hereinafter, referred to as a “host vehicle), in which the communication device 12 is mounted, or outputs signals received from the outside of the host vehicle toward the ECU 11 according to a request from the ECU 11.

The GNSS device 13 receives satellite signals transmitted from three or more satellites, preferably, four or more satellites over the vehicle 10, thereby positioning a position of the host vehicle. The GNSS device 13 is connected to the ECU 11 in a communicable manner through a one-to-one communication line or the in-vehicle network, and positioning information of the GNSS device 13, that is, positional information of the host vehicle (vehicle 10) is loaded to the ECU 11.

The wheel speed sensor 14 is a known detection unit that detects a wheel speed of each wheel of the vehicle 10. The wheel speed sensor 14 outputs detection information (hereinafter, referred to as “wheel speed information”) corresponding to the wheel speed of each wheel, and the wheel speed information is loaded to the ECU 11 through a one-to-one communication line or the in-vehicle network. With this, the ECU 11 can detect (acquire) a vehicle speed of the vehicle 10 based on the wheel speed information.

As shown in FIG. 3, the ECU 11 includes, for example, a communication environment information transmission unit 111 as a functional unit that is implemented by executing one or more programs installed on the auxiliary storage device 11A on the CPU 11C. The ECU 11 uses a unique vehicle information storage unit 112, a communication environment map storage unit 113, and the like. The unique vehicle information storage unit 112 and the communication environment map storage unit 113 can be implemented, for example, using the auxiliary storage device 11A, an external storage device connected to the ECU 11 in a communicable manner, or the like.

The communication environment information transmission unit 111 acquires the communication environment information (that is, the communication environment status information and the communication environment related vehicle information) and the positional information of the host vehicle in a predetermined processing cycle when the host vehicle (vehicle 10) is positioned within the target area. In this case, an aspect in which the communication environment information transmission unit 111 automatically performs the acquisition of the above-described information under a predetermined condition may be made or an aspect in which the communication environment information transmission unit 111 performs the acquisition of the above-described information with a command from the center server 20 as a trigger may be made. In the latter case, the center server 20 may transmit the command relating to the information acquisition to the vehicle 10 while ascertaining the position of each vehicle 10 based on the positional information of the vehicles 10 sequentially uploaded from the vehicles 10. Then, the communication environment information transmission unit 111 transmits identification information (hereinafter, referred to as “vehicle identification information”) of the host vehicle (vehicle 10) and a set of the acquired communication environment information and the positional information of the host vehicle corresponding to the communication environment information to the center server 20 through the communication device 12. The vehicle identification information is, for example, a model number of the vehicle 10, a vehicle identification number (VIN) of the vehicle 10, a unique vehicle identifier (ID) specified in advance for each vehicle 10, or the like. A transmission timing of the above-described information to the center server 20 may be optional. For example, the set of corresponding information may be transmitted to the center server 20 in real time in parallel with the acquisition of the above-described information. The above-described set of information accumulated to a certain extent may be transmitted to the center server 20 at a predetermined timing (for example, at the time of ignition-off of the host vehicle, at the time of ignition-on of the host vehicle, or the like).

Specifically, the communication environment information transmission unit 111 may acquire the communication environment status information (for example, a measured value of reception sensitivity of radio waves of 5G output from a base station) from the communication device 12. The communication environment information transmission unit 111 may read and acquire information relating to the type of the antenna of 5G of the host vehicle or the attachment position of the antenna registered in advance from the unique vehicle information storage unit 112. The communication environment information transmission unit 111 may acquire the positional information of the host vehicle from the GNSS device 13. The communication environment information transmission unit 111 may acquire information relating to the moving direction of the vehicle 10 based on a history of the positional information of the host vehicle acquired from the GNSS device 13. The communication environment information transmission unit 111 may acquire information relating to the vehicle speed of the host vehicle based on the wheel speed information loaded from the wheel speed sensor 14.

In the communication environment related vehicle information, Unique vehicle information (for example, information relating to the type of the antenna of 5G or the attachment position of the antenna) that is basically unchanged may not be included in all sets of information transmitted to the center server 20. For example, an aspect in which the unique vehicle information in the communication environment related vehicle information is included solely in the set of information initially transmitted between ignition-on and ignition-off of the vehicle 10 may be made. The unique vehicle information in the communication environment related vehicle information may not be transmitted to the center server 20. This is because, in a case where a correspondence relationship between the vehicle identification information and the unique vehicle information of the vehicle 10 corresponding to the vehicle identification information is held in advance, the center server 20 can ascertain the unique vehicle information of the vehicle 10 as a transmission source from the vehicle identification information included in the received set of information.

In the unique vehicle information storage unit 112, the vehicle information unique to the host vehicle (vehicle 10) is stored in advance. In the unique vehicle information storage unit 112, for example, the vehicle identification information of the host vehicle, information relating to the type of the antenna of 5G mounted in the host vehicle (communication device 12), information relating to the attachment position of the antenna, and the like are included.

In the communication environment map storage unit 113, the communication environment map distributed from the center server 20 is stored. With this, the ECU 11 can ascertain a communication environment of 5G at a current position of the vehicle 10 using the communication environment map. The communication environment map stored in the communication environment map storage unit 113 may be updated with a latest communication environment map each time the latest communication environment map is distributed from the center server 20. With this, the ECU 11 can ascertain the latest communication environment of 5G at the current position in the vehicle 10.

Configuration of Center Server

The functions of the center server 20 may be implemented by any hardware or a combination of hardware and software. As shown in FIG. 2B, for example, the center server 20 includes a drive device 21, an auxiliary storage device 22, a memory device 23, a CPU 24, an interface device 25, a display device 26, and an input device 27. The devices are connected by a bus B2.

Programs that implement various functions of the center server 20 are provided, for example, by a portable recording medium 21A, such as a compact disc read only memory (CD-ROM), a digital versatile disc read only memory (DVD-ROM), or a universal serial bus (USB) memory. In a case where the recording medium 21A, on which the programs are recorded, is set in the drive device 21, the programs are installed on the auxiliary storage device 22 from the recording medium 21A through the drive device 21. The programs may be downloaded from another computer through a communication network and may be installed on the auxiliary storage device 22.

The auxiliary storage device 22 stores various installed programs and stores needed files, data, and the like.

When a start instruction of the programs is given, the memory device 23 reads the programs from the auxiliary storage device 22 and stores the programs.

The CPU 24 executes various programs stored in the memory device 23 and implements various functions related to the center server 20 according to the programs.

The interface device 25 is used as an interface for connection to the communication network (for example, the communication network NW).

The display device 26 displays a graphical user interface (GUI), for example, according to the programs executed by the CPU 24.

The input device 27 is used to make a worker, a manager, or the like of the center server 20 input various operation instructions relating to the center server 20.

The center server 20 includes, for example, a communication environment information acquisition unit 201, a communication environment map generation unit 204, and a communication environment map distribution unit 206, for example, as functional units that are implemented by executing one or more programs installed on the auxiliary storage device 22 on the CPU 24. The center server 20 uses a communication environment information storage unit 202, a basic information storage unit 203, a communication environment map storage unit 205, and the like. The communication environment information storage unit 202, the basic information storage unit 203, and the communication environment map storage unit 205 may be implemented, for example, by the auxiliary storage device 22, an external storage device connected to the center server 20 in a communicable manner, or the like.

The communication environment information acquisition unit 201 acquires the vehicle identification information of the vehicle 10 as a transmission source and the set of the communication environment information of the vehicle 10 and the positional information of the vehicle 10 corresponding to the communication environment information received from each of the vehicles 10, and stores the acquired information in the communication environment information storage unit 202.

In the communication environment information storage unit 202, the set of the vehicle identification information of the vehicle 10, the communication environment information of the vehicle 10, and the positional information of the vehicle 10 corresponding to the communication environment information is stored (accumulated). For example, in the communication environment information storage unit 202, a database constituted by record groups of the vehicle identification information of the vehicle 10, the communication environment information of the vehicle 10, the positional information of the vehicle 10, and the like is held. With this, the communication environment map generation unit 204 can set an extraction condition relating to the communication environment information of the vehicle 10 or the positional information of the vehicle 10 and can extract a desired record.

In the basic information storage unit 203, basic information for generating the communication environment map is stored. In the basic information storage unit 203, for example, the vehicle identification information of each of the vehicles 10 may be stored. In the basic information storage unit 203, for example, information (for example, information relating to the type of the antenna of 5G or the attachment position of the antenna) relating to a communication function of 5G of each of the vehicles 10 may be stored. In the basic information storage unit 203, for example, map information including the target area of the communication environment map may be stored.

The communication environment map generation unit 204 (an example of a determination unit) determines suitability of the communication environment in the vehicle 10 at each of a plurality of points (hereinafter, referred to as “target points) specified within the target area based on the record groups stored in the communication environment information storage unit 202. For example, the communication environment map generation unit 204 extracts the record groups including the positional information of the vehicle 10 corresponding to the target point from the communication environment information storage unit 202 and determines the communication environment in the vehicle 10 at the target point based on the communication environment status information of the respective extracted record groups. Then, the communication environment map generation unit 204 generates a communication environment map, in which the target point within the target area and a determination result of the communication environment of 5G in the vehicle 10 at the target point are associated with each other, based on the determination result. The generated communication environment map is stored in the communication environment map storage unit 205. The target points may be specified, for example, at comparatively short intervals (for example, several meters to ten-odd meters) on road links within the target area. The communication environment of 5G may be determined, for example, in such an aspect as to be relatively improved as an average value of the communication environment status information (the measured values of the reception sensitivity of the radio waves of 5G) included in the extracted record groups of the communication environment information storage unit 202 increases. The communication environment of 5G may be determined after records having the communication environment status information corresponding to an abnormal value or an outlier value are excluded from the extracted record groups.

Specifically, the communication environment map generation unit 204 determines the communication environment of 5G in the vehicle 10 at the target point taking into consideration a difference in communication environment related vehicle information among the vehicles 10.

For example, the communication environment map generation unit 204 may determine the communication environment of 5G in the vehicle 10 at the target point for each type of the antenna of 5G attached to the vehicle 10. This is because the communication environment of 5G in the vehicle 10 may change depending on the type of the antenna of 5G. In this case, the communication environment map generation unit 204 extracts the record groups of each type of the antenna of 5G attached to the vehicle 10 from among the record groups stored in the communication environment information storage unit 202. Then, the communication environment map generation unit 204 may further extract the record groups of each target point based on the positional information of the vehicle 10 on the respective extracted record groups and may determine the communication environment of 5G in the vehicle 10 based on the average value of the reception sensitivity (the measured values) of the radio waves of 5G in the extracted record groups. With this, the communication environment map generation unit 204 can determine the communication environment of 5G in the vehicle 10 at each target point and for each type of the antenna of 5G of the vehicle 10.

The communication environment map generation unit 204 may determine the communication environment of 5G in the vehicle 10 at the target point for each of a plurality of sections (hereinafter, referred to as “attachment position sections”) specified in advance relating to the attachment position of the antenna of 5G attached to the vehicle 10. This is because the communication environment of 5G in the vehicle 10 may change depending on the attachment position of the antenna of 5G. In this case, the communication environment map generation unit 204 extracts the record groups of each attachment position section of the antenna of 5G attached to the vehicle 10 from among the record groups stored in the communication environment information storage unit 202. Then, the communication environment map generation unit 204 may further extract the record groups of each target point based on the positional information of the vehicle 10 on the respective extracted record groups and may determine the communication environment of 5G in the vehicle 10 based on the average value of the reception sensitivity (measured values) of the radio waves of 5G in the extracted record groups. With this, the communication environment map generation unit 204 can determine the communication environment of 5G in the vehicle 10 at each target point and for each attachment position section of the antenna of 5G of the vehicle 10.

The communication environment map generation unit 204 may determine the communication environment of 5G in the vehicle 10 at the target point for each of a plurality of sections (hereinafter, referred to as “vehicle speed sections”) specified in advance relating to the vehicle speed of the vehicle 10. This is because the communication environment of 5G in the vehicle 10 may change depending on the degree of the vehicle speed of the vehicle 10 due to the characteristic that a radio wave having strong directivity using beam forming of 5G is used. In this case, the communication environment map generation unit 204 extracts the record groups of each vehicle speed section from among the record groups stored in the communication environment information storage unit 202. Then, the communication environment map generation unit 204 may further extract the record groups of each target point based on the positional information of the vehicle 10 on the respective extracted record groups and may determine the communication environment of 5G in the vehicle 10 based on the average value of the reception sensitivity (measured values) of the radio waves of 5G in the extracted record groups. With this, the communication environment map generation unit 204 can determine the communication environment of 5G in the vehicle 10 at each target point and for each vehicle speed section.

The communication environment map generation unit 204 may determine the communication environment of 5G in the vehicle 10 at each target point for each moving direction of the vehicle 10. This is because the communication environment of 5G in the vehicle 10 may change depending on the moving direction of the vehicle 10 due to the characteristic that the radio wave having strong directivity using beam forming of 5G is used. In regard to the moving direction of the vehicle 10, two or more moving directions are specified in advance at each target point, excluding when the target point is a one-way street. For example, when the target point is not an intersection, excluding a one-way street, two directions of one direction and an opposite direction are specified in advance, and when the target point is an intersection, three or more directions according to the number of intersecting roads are specified in advance. In this case, the communication environment map generation unit 204 extracts the record groups of each of the target points from among the record groups stored in the communication environment information storage unit 202 based on the positional information of the vehicle 10. Then, the communication environment map generation unit 204 may further extract the record groups of each moving direction of the vehicle 10 on the respective extracted record groups and may determine the communication environment of 5G in the vehicle 10 based on the average value of the reception sensitivity (the measured values) of the radio waves of 5G in the extracted record groups. With this, the communication environment map generation unit 204 can determine the communication environment of 5G in the vehicle 10 at each target point and for each moving direction of the vehicle 10.

The communication environment map generation unit 204 may determine the communication environment of 5G in the vehicle 10 at the target point using the same method taking into consideration two or more conditions of the conditions unique to the vehicle 10, such as the type of the antenna of 5G, the attachment position section of the antenna of 5G, the vehicle speed section of the vehicle 10, and the moving direction of the vehicle 10. For example, the communication environment map generation unit 204 may determine the communication environment of 5G in the vehicle 10 at the target point for each type of the antenna of 5G and each attachment position section of the antenna of 5G. For example, the communication environment map generation unit 204 may determine the communication environment of 5G in the vehicle 10 at the target point for each vehicle speed section and each moving direction of the vehicle 10.

The communication environment map generation unit 204 generates a communication environment map, in which positional information (for example, a latitude and a longitude, Geohash, or the like)of the target point and a determination result of the communication environment of 5G in the vehicle 10 at the target point are associated with each other, for each of the target points. In this case, a plurality of determination results by the type of the antenna of 5G of the vehicle 10, the attachment position section, the vehicle speed section, the moving direction of the vehicle 10, or the like is associated with each target point. With this, the ECU 11 of the vehicle 10 can select the determination result conforming to the type of the antenna of 5G of the host vehicle, the attachment position section, the vehicle speed section, the moving direction, or the like from among the determination results associated with the target point corresponding to a current position of the host vehicle in the communication environment map. For this reason, the ECU 11 of the vehicle 10 can more appropriately ascertain the communication environment of 5G in the host vehicle.

The communication environment map generation unit 204 may generate a plurality of communication environment maps by the type of the antenna of 5G of the vehicle 10, the attachment position section, the vehicle speed section, the moving direction of the vehicle 10, or the like, instead of generating the communication environment map in which the determination results are associated with each target point.

The communication environment map generation unit 204 may generate a communication environment map (hereinafter, referred to as a “communication environment map image”) as image information visually representing the communication environment in the vehicle 10 in the target area. With this, the ECU 11 of the vehicle 10 can make the user visually recognize (ascertain) the communication environment of 5G in the vehicle 10 through a display device (for example, a meter, a display of a navigation device, or the like) mounted in the vehicle 10. For example, the center server 20 may provide the communication environment map image to a predetermined external device as described below. With this, the center server 20 can make the user of the external device visually recognize (ascertain) the communication environment of 5G in the vehicle 10 through the communication environment map image.

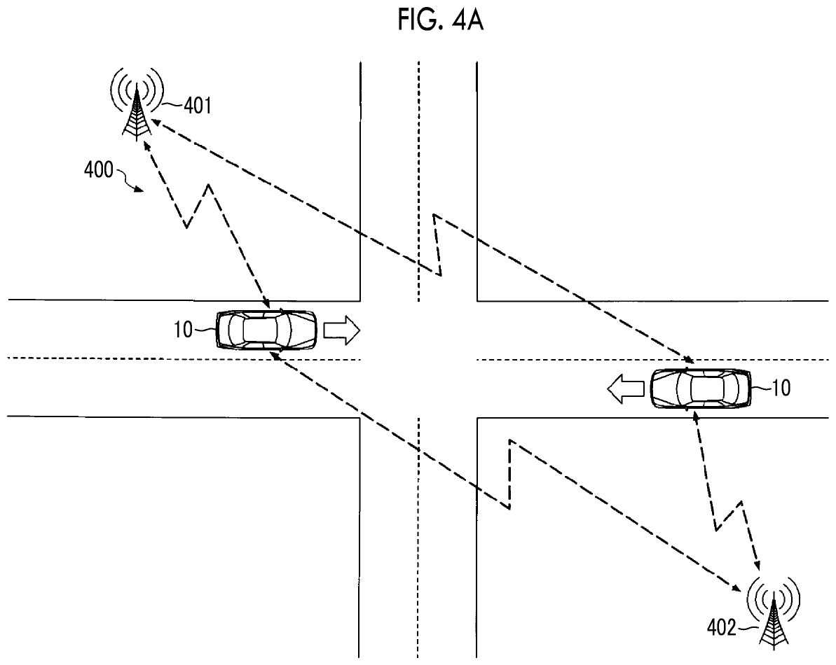

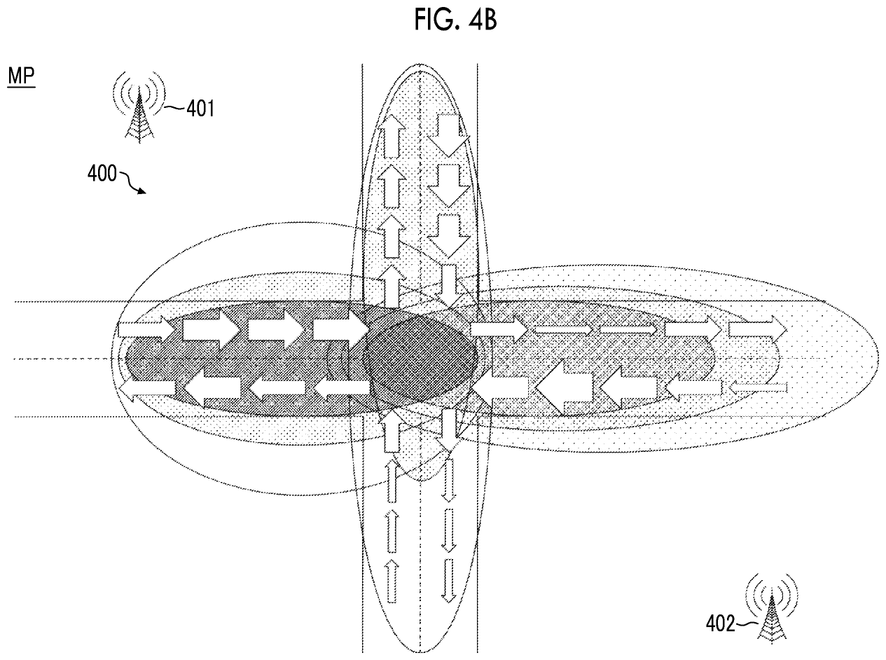

For example, FIGS. 4A and 4B are diagrams illustrating an example (communication environment map image MP) of the communication environment map image. Specifically, FIG. 4A is a diagram showing a situation of a target area 400 including an intersection where two roads intersect, and FIG. 4B is a diagram showing a communication environment map image MP of the target area 400.

As shown in FIG. 4A, base stations 401, 402 corresponding to 5G are provided in the target area 400. The vehicles 10 passing through the target area 400 receive radio waves of 5G from the base stations 401, 402, thereby being able to use a communication function of 5G.

As shown in FIG. 4B, in the example, ranges (hereinafter, referred to as “high reception sensitivity ranges”) in the target area 400 in which a communication environment of 5G is relatively satisfactory and reception sensitivity of the radio waves of 5G from the base stations 401, 402 is relatively high are surrounded by solid lines in the communication environment map image MP. The high reception sensitivity ranges are drawn such that color (hatching) becomes darker as the reception sensitivity of the radio waves of 5G from the base stations 401, 402 is higher. Each high reception sensitivity range may be set, for example, as geographical range, in which an average value of the reception sensitivity (measured values) of the radio waves of 5G at the target point calculated without taking into consideration the communication environment related vehicle information of the vehicle 10 is relatively high, based on the record groups of the communication environment information storage unit 202. The high reception sensitivity range may be set based on information that is disclosed by a communication carrier.

In the example, suitability of a communication environment, that is, the degree of the reception sensitivity of the radio waves of 5G from the base stations 401, 402 is displayed for each of the moving directions of the two roads within the target area in the communication environment map image MP. Specifically, in the communication environment map image MP, a white arrow indicating the moving direction is displayed at each target point on the road within the high reception sensitivity range, and the arrow becomes thicker as the reception sensitivity of the radio waves of 5G is higher. With this, the communication environment map image MP can visually express that a difference occurs in the communication environment of 5G according to the moving direction even at the same place (target point) in the high reception sensitivity range within the target area 400.

Returning to FIG. 3, the communication environment map generation unit 204 may sequentially update the communication environment map based on new communication environment information accumulated in the communication environment information storage unit 202.

For example, the communication environment map generation unit 204 generates the communication environment map in each predetermined period (for example, several weeks or several months), and the communication environment map of the communication environment map storage unit 205 is updated with the newly generated communication environment map. In this case, communication environment map generation unit 204 may generate the communication environment map based on the record groups stored in the communication environment information storage unit 202 after the generation of the previous communication environment map. With this, it is possible to reflect the latest communication environment in the target area in the communication environment map.

In the communication environment map storage unit 205, as described above, the communication environment map generated by the communication environment map generation unit 204 is stored. The communication environment map of the communication environment map storage unit 205 may be updated based on the communication environment map newly generated by the communication environment map generation unit 204 as described above.

The communication environment map distribution unit 206 distributes the communication environment map stored in the communication environment map storage unit 205 to the vehicles 10. The communication environment map distribution unit 206 may push-distribute the communication environment map to the vehicle 10, for example, each time the new communication environment map is stored in the communication environment map storage unit 205 or may distribute the communication environment map to the vehicle 10 according to a request signal from the vehicle 10. With this, the ECU 11 of the vehicle 10 can more appropriately ascertain the communication environment of 5G in the host vehicle in conformity with the conditions (for example, the type of the antenna of 5G, the attachment position of the antenna, the vehicle speed, the moving direction, and the like) peculiar to the host vehicle using the communication environment map. For this reason, the ECU 11 of the vehicle 10 can appropriately determine a situation in which the communication environment of 5G in the host vehicle is relatively satisfactory and can upload enormous data (for example, image information of an in-vehicle camera, or the like) to a predetermined external device in conformity with the timing. That is, the ECU 11 of the vehicle 10 can more quickly complete the upload of enormous data to the external device. Thus, the center server 20 can suppress, for example, a situation that enormous data is uploaded from the vehicle 10 in a situation in which the communication environment of 5G is relatively unsatisfactory, thereby needing a time for communication processing and affecting other kinds of processing in the vehicle 10.

The communication environment map distribution unit 206 may transmit the communication environment map to a target other than the vehicle 10. For example, the communication environment map distribution unit 206 may distribute the communication environment map to a vehicle different from the vehicle 10. The communication environment map distribution unit 206 may distribute the communication environment map to a predetermined external device related to a client corporation or the like that wants to use the communication environment map.

Operation of Embodiment

Next, the operation of the information providing system 1 (center server 20) according to the embodiment will be described.

In the embodiment, the communication environment map generation unit 204 determines, based on information (communication environment status information) representing a communication environment of 5G at a predetermined point (target point) acquired by the vehicle 10 passing through the predetermined point and vehicle information(communication environment related vehicle information) relating to the communication environment of 5G at the predetermined point, a communication environment of 5G in the vehicle 10 at a predetermined point.

With this, the center server 20 can consider the conditions peculiar to the vehicle 10 affecting the communication environment of 5G based on the communication environment related vehicle information. For this reason, the center server 20 can appropriately determine the communication environment of 5G in the vehicle 10 at the predetermined point taking into consideration the conditions peculiar to the vehicle 10 affecting the communication environment of 5G.

In the embodiment, in the communication environment related vehicle information, at least one of a vehicle speed of the vehicle 10 at the predetermined point, a moving direction of the vehicle 10 at the predetermined point, a type of an antenna of 5G mounted in the vehicle 10, and an attachment position of the antenna of 5G in the vehicle 10 may be included.

With this, the center server 20 can specifically determine the communication environment of 5G at the predetermined point taking into consideration the conditions peculiar to the vehicle 10, such as the vehicle speed of the vehicle 10, the moving direction of the vehicle 10, the type of the antenna of 5G, and the attachment position of the antenna of 5G.

In the embodiment, the communication environment map generation unit 204 determines the communication environment of 5G in the vehicle 10 at the predetermined point based on the communication environment status information acquired by the vehicles 10 passing through the predetermined point and the communication environment related vehicle information. Then, the communication environment map generation unit 204 may generate map information (communication environment map), in which a geographical range (target area) including a plurality of predetermined points and the communication environment of 5G in the vehicle 10 are associated with each other, based on determination results for the predetermined points.

With this, the center server 20 can ascertain the communication environment of 5G in the vehicle 10 for a specific geographical range by itself or can make an external device ascertain the communication environment of 5G in the vehicle 10 for the specific geographical range based on the communication environment map.

Modifications and Alterations

Although the mode for carrying out the disclosure has been described in detail, the disclosure is not limited to such a specific embodiment, and various modifications and alterations can be made without departing from the spirit and scope of the disclosure described in the claims.

For example, in the above-described embodiment, the center server 20 may determine the communication environment in the vehicle 10 at the predetermined point based on the communication environment information of one vehicle 10 (for example, the last vehicle 10 passing through the target point).

In the above-described embodiment and the modification example, the center server 20 may determine a communication environment of 5G at a current position of the vehicle 10 in real time in conformity with current positional information of the vehicle 10 or the communication environment related vehicle information based on the record groups of the communication environment information storage unit 202, instead of generating the communication environment map. With this, the center server 20 can determine, for example, a timing, at which the communication environment of 5G is satisfactory, for each vehicle 10 and can transmit a command for uploading enormous data (for example, image data of the in-vehicle camera, or the like) to the vehicle 10.

In the above-described embodiment and the modification example, the function of the communication environment map generation unit 204 may be transferred to another server (an example of an information processing device) connected to the center server 20 in a communicable manner.

In the above-described embodiment and the modification example, the function of the communication environment map generation unit 204, specifically, the function of determining the communication environment in the vehicle 10 at the predetermined point may be transferred to each vehicle 10, for example, the ECU 11 (an example of an information processing device). In this case, the ECU 11 of the vehicle 10 may determine a communication environment at a current position of the host vehicle based on communication environment information of non-host vehicles 10 provided from the center server 20 or communication environment information of the host vehicle acquired by the host vehicle.

What is claimed is:

1. An information processing device comprising a determination unit configured to, based on information representing a communication environment of 5G at a predetermined point acquired by a vehicle passing through the predetermined point and vehicle information relating to the communication environment of 5G at the predetermined point, determine a communication environment of 5G in a vehicle at the predetermined point.

2. The information processing device according to claim 1, wherein the vehicle information relating to the communication environment includes at least one of a vehicle speed of a vehicle at the predetermined point, a moving direction of a vehicle at the predetermined point, a type of an antenna of 5G mounted in a vehicle, and an attachment position of the antenna in a vehicle.

3. The information processing device according to claim 1, wherein the determination unit is configured to determine the communication environment of 5G in a vehicle at the predetermined point based on information representing the communication environment acquired by a plurality of vehicles passing through the predetermined point and the vehicle information relating to the communication environment and generate map information, in which a geographical range including a plurality of the predetermined points and a communication environment of 5G in a vehicle are associated with each other, based on a determination result for the predetermined points.

4. An information processing method that is executed by an information processing device, the information processing method comprising a determination step of, based on information representing a communication environment of 5G at a predetermined point acquired by a vehicle passing through the predetermined point and vehicle information relating to the communication environment of 5G at the predetermined point, determining a communication environment of 5G in a vehicle at the predetermined point.

5. A program causing an information processing device to execute a determination step of, based on information representing a communication environment of 5G at a predetermined point acquired by a vehicle passing through the predetermined point and vehicle information relating to the communication environment of 5G at the predetermined point, determining a communication environment of 5G in a vehicle at the predetermined point.
